(19) United States
(12) Patent Application Publication
(10) Pub. No.: US 2024/0334099 A1
(43) Pub. Date: Oct. 3, 2024

(54) DATA DOUBLE OVERSAMPLING METHOD, SYSTEM DEVICE AND STORAGE MEDIUM

(71) Applicant: SHENZHEN PANGO MICROSYSTEMS CO., LTD, Shenzhen (CN)

(72) Inventors: Siyuan WU, Shenzhen (CN); Qiyan ZHANG, Shenzhen (CN); Jin ZHANG, Shenzhen (CN); Chaowei BAO, Shenzhen (CN); Yunliang YANG, Shenzhen (CN)

(21) Appl. No.: 18/625,972

(22) Filed: Apr. 3, 2024

(30) Foreign Application Priority Data
Apr. 3, 2023 (CN) 202310341628.7

(51) Int. Cl. H04Q 11/00

(52) U.S. Cl. CPC H04Q 11/0067; H04Q 2011/0079

(57) ABSTRACT

A data double oversampling method includes: obtaining the initial sampling phase of two adjacent bits of the preamble in a GPON frame and the phase label of each initial sampling phase. Based on whether the adjacent phase labels of the target jump edge before and after shifting are equal and whether the first reference sampling phase is located at the target jump edge, shifting each sampling phase after shift again to obtain the optimal sampling phase corresponding to the two adjacent bits, in order to sample the valid data. The method samples the valid data by determining the optimal sampling phase at the preamble, and can stably complete the phase locking of the recovered data within the time specified in the protocol; and there is no need to change hardware devices which saves costs.

### FIELD OF THE DISCLOSURE

The invention relates to the field of electronic technology, in particular to a data double oversampling method, system, device and storage medium.

### BACKGROUND

GPON (Gigabit Passive Optical Network) technology has many advantages, such as high bandwidth, high efficiency, large coverage, rich user interfaces and so on, GPON protocol has an uplink rate of 1.24416 Gbps and a downlink rate of 2.48832 Gbps. At present, the scheme of CDR (Clock Data Recovery) receiving data at the receiving terminal is a 4 times oversampling scheme based on SerDes in FPGA (Field Programmable Gate Array). In this scenario, the transmitting terminal sends data at the rate of 1.24416 Gbps in the GPON uplink, and the SerDes of the receiving terminal samples at the line rate of 4.97664G. The received data is sampled by four times oversampling, the correct sampling point is found first, and then the drift of the sampling point is tracked, which can realize the phase locking within the specified time in the agreement.

However, as FTTR enters thousands of households, the optical modem at the client is usually connected to multiple onus, so the uplink rate of GPON protocol needs to be upgraded to 2.48832 Gbps. However, when the transmitting terminal sends data at the rate of 2.488 Gbps in the GPON uplink, the SerDes' clock frequency of the receiving terminal cannot meet the requirements.

Therefore, there is an urgent need for a data sampling method for the transmitting terminal to send data at the rate of 2.48832 Gbps in the GPON uplink.

### SUMMARY

The invention provides a data double oversampling method, system, device and storage medium, the main purpose is to provide a data double oversampling method for uplink 2.48832 Gbps transmission scenarios.

The first aspect, the embodiment of the invention provides a data double oversampling method, which comprises:
S110, for the two adjacent bits of the preamble in a GPON frame, obtaining the initial sampling phase corresponding to the two adjacent bits and the phase label of each initial sampling phase, the GPON frame includes the preamble and valid data;
S120, shifting each initial sampling phase to obtain each sampling phase after shift;
S130, based on whether the adjacent phase labels of the target jump edge before and after shifting are equal and whether the first reference sampling phase is located at the target jump edge, shifting each sampling phase after shift again, obtaining the optimal sampling phase corresponding to the two adjacent bits. The optimal sampling phase is closer to the middle phase of the corresponding preamble. The first reference sampling phase is the sampling phase after shift which is adjacent to the target jump edge and behind the target jump edge;
S140, sampling the valid data based on the optimal sampling phase corresponding to each bit of the preamble.

Optionally, wherein that “based on whether the adjacent phase labels of the target jump edge before and after shifting are equal and whether the first reference sampling phase is located at the target jump edge, shifting each sampling phase after shift again” comprises:
determining whether the first reference sampling phase is located at the target jump edge;
in the case where the first reference sampling phase is located at the target jump edge, shifting each sampling phase after shift again according to the first preset shift rule;
in the case where the first reference sampling phase is not located at the target jump edge, obtaining the first adjacent phase labels of the target jump edge according to the adjacent initial sampling phase of the target jump edge and the phase label of each initial sampling phase;
obtaining the second adjacent phase labels of the target jump edge according to the adjacent sampling phase after shift of the target jump edge;
in the case where the first adjacent phase labels and the second adjacent phase labels are equal, shifting each sampling phase after shift again according to the second preset shift rule;
in the case where the first adjacent phase labels and the second adjacent phase labels are not equal, shifting each sampling phase after shift again according to the third preset shift rule.

Optionally, the first preset shift rule comprises: shifting each sampling phase after shift backward by 0.25 bit;
the second preset shift rule comprises: shifting each sampling phase after shift forward by 0.125 bit;
the third preset shift rule comprises: shifting each sampling phase after shift backward by 0.125 bit.

Optionally, wherein before that “obtaining the first adjacent phase labels of the target jump edge according to the adjacent initial sampling phase of the target jump edge and the phase label of each initial sampling phase”, the method comprises:
obtaining initial sampling data by sampling the corresponding bit of each initial sampling phase;
performing an XOR on two adjacent initial sampling data;
in the case where the XOR value of the two adjacent initial sampling data is 1, the jump edge between the initial sampling phase corresponding to the two adjacent initial sampling data is taken as the target jump edge.

Optionally, wherein that “obtaining the optimal sampling phase corresponding to the two adjacent bits” comprises:
taking the initial sampling phase which is adjacent to the jump edge and located behind the target jump edge as the second reference sampling phase;
obtaining each final sampling phase after shifting each sampling phase after shift again;
taking the final sampling phase adjacent to the final reference phase as the optimal sampling phase, and The final reference phase is obtained by shifting the second reference sampling phase.

Optionally, the steps S110 to S130 are executed concurrently at least once.

Optionally, wherein that “shifting each initial sampling phase to obtain each sampling phase after shift” comprises:
shifting each initial sampling phase forward by 0.25 bit to obtain each sampling phase after shift.

The second aspect, the embodiment of the invention provides a data double oversampling system, which comprises:
the receiving module, for obtaining the initial sampling phase corresponding to the two adjacent bits and the phase label of each initial sampling phase, the GPON frame includes the preamble and valid data, for the two adjacent bits of the preamble in a GPON frame;
the first shift module, for shifting each initial sampling phase to obtain each sampling phase after shift;
the second shift module, for shifting each sampling phase after shift again, obtaining the optimal sampling phase corresponding to the two adjacent bits, based on whether the adjacent phase labels of the target jump edge before and after shifting are equal and whether the first reference sampling phase is located at the target jump edge. The optimal sampling phase is closer to the middle phase of the corresponding preamble. The first reference sampling phase is the sampling phase after shift which is adjacent to the target jump edge and behind the target jump edge;
the sampling module, for sampling the valid data based on the optimal sampling phase corresponding to each bit of the preamble.

The third aspect, the embodiment of the invention provides a data double oversampling device, which comprises a processor and a memory storing program instructions coupled to the processor; the processor being configured to execute the program instructions of memory storage in order to implement the method of any one of the first aspect.

The fourth aspect, the embodiment of the invention provides a storage medium which stores program instructions, when the program instructions being executed by a processor, the data double oversampling method of any one of the first aspect being implemented.

The invention provides a data double oversampling method, system, device and storage medium, the initial sampling phase of the preamble bit is shifted twice, and finally extracting the optimum sampling phase. The optimal sampling phase is made close to the middle phase of the corresponding preamble by two shifts, which ensure that there is sufficient window sampling margin, and improve sampling accuracy, and increase sampling accuracy. By sampling the valid data with the optimal sampling phase which is determined at the preamble, the phase locking of the received data can be stably completed within the time specified in the protocol; and the method does not need to change the hardware equipment, thus saving the cost.

### BRIEF DESCRIPTION OF THE DRAWINGS

FIG. 1 is the flow chart of a data double oversampling method provided by the embodiment of the invention;

FIG. 2 is a schematic diagram of the initial sampling phase corresponding to two adjacent bits in the embodiment of the invention;

FIG. 3 is a specific flow chart for determining a shift method according to adjacent phase labels in the embodiment of the invention;

FIG. 4 is a schematic diagram of the first interval segment of the third initial sampling phase in D2 in the embodiment of the invention;

FIG. 5 is a schematic diagram of the second interval segment of the third initial sampling phase in D2 in the embodiment of the invention;

FIG. 6 is a schematic diagram of the third interval segment of the third initial sampling phase in D2 in the embodiment of the invention;

FIG. 7 is a schematic diagram of the fourth interval segment of the third initial sampling phase in D2 in the embodiment of the invention;

FIG. 8 is the structural diagram of a data double oversampling system in the embodiment of the invention;

FIG. 9 is the structural diagram of a data double oversampling device in the embodiment of the invention.

The implementation, functional characteristics and advantages of the invention will be further explained in conjunction with the embodiments, with reference to the accompanying drawings.

### DETAILED DESCRIPTION OF PREFERRED EMBODIMENTS

The embodiments of the invention are described in detail below. Examples of embodiments are shown in the drawings, in which the same or similar reference numerals throughout represent the same or similar elements, or elements with the same or similar functions. The embodiments described below by reference to the accompanying drawings are exemplary and are only for the purpose of interpreting the invention, the embodiments can not be understood as limiting the invention.

In order to enable person skilled in the art to better understand the scheme of the invention, the technical scheme in the embodiment of the invention will be clearly and completely described below in combination with the drawings. Obviously, the described embodiments are only part of the embodiments of the invention, not all of them. Based on the embodiments of the invention, all other embodiments obtained by person skilled in the art without creative work fall within the scope of protection of the invention.

In the embodiment of the invention, at least one refers to one or more; multiple refers to two or more. In the description of the invention, “first”, “second”, “third” and other words are only used for the purpose of distinguishing the description, and cannot be understood as indicating or implying relative importance, nor as indicating or implying order.

The reference to “one embodiment” or “some embodiments” described in this specification means that one or more embodiments of the invention include specific features, structures or features described in connection with the embodiment. Thus, in this specification, the terms “including”, “containing”, “having” and their variations mean “including but not limited to” unless otherwise specifically emphasized.

The application scenario in the embodiment is that multiple optical network units are mounted to an optical modem. In the embodiment, the transmitting terminal is the optical modem, and the receiving terminal is the optical network unit. The optical modem sends the GPON frame to the optical network unit according to the GPON protocol. After receiving the GPON frame, the optical network unit executes the data double oversampling method to sample the GPON frame, so as to obtain the transmitted data.

In the embodiment, the transmitting terminal sends GPON frames at a rate of 2.48832 Gbps. If the receiving terminal samples GPON frames at a frequency of 4 times, the SerDes with a clock frequency of 6.6G in the present FPGA cannot meet the requirements. Therefore, in the embodiment, the receiving terminal samples GPON frames at a frequency of 2 times. The uplink data of GPON protocol will undergo sudden interruption and burst transmission, when the uplink data is upgraded to 2.48832 Gbps, the receiving terminal is required to be able to stably complete the phase locking of the received data within the time specified in the protocol.

It should be noted that SerDes is a set of communication system. The SerDes includes serializer and deserializer. the serializer is a device that converts parallel data into serial data, and the deserializer is a device that restores serial data into parallel data. In the actual application scenario, the receiving terminal realizes the corresponding data receiving function through FPGA. FPGA usually has built-in SERDES, so the receiving end can receive data through FPGA's built-in SERDES.

When the transmitting terminal communicates with the receiving terminal, the transmitting terminal sends GPON frames using Serializer. When the receiving terminal receives the GPON frame, according to the allocated time slot, the optical modem is in a non luminous state. After receiving the optical signal of the GPON frame, the receiving terminal converts the optical signal of the GPON frame into the electrical signal of the GPON frame and sends it to the deserializer.

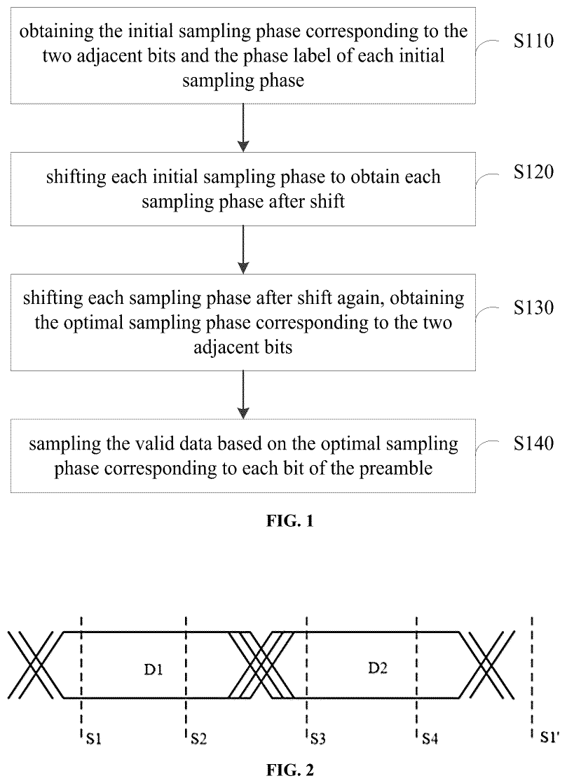

FIG. 1 is the flow chart of a data double oversampling method provided by the embodiment of the invention, as shown in FIG. 1, the method comprises:
S110, for the two adjacent bits of the preamble in GPON frame, obtaining the initial sampling phase corresponding to the two adjacent bits and the phase label of each initial sampling phase, the GPON frame includes the preamble and valid data;

When the receiving terminal is idle, the receiving terminal receives the GPON frame which refers to the electrical signal of the GPON frame converted from the optical signal of the GPON frame. The GPON frame includes two parts: the preamble and the valid data, the function of the preamble is to synchronize the bit of the transmitting terminal and the receiving terminal, the valid data refers to the valid information contained in the GPON frame.

To facilitate the description of the invention, the preamble in the embodiment is 4 ′b1010 is taken as an example, wherein 4 represents the number of bit of the preamble, B represents that the preamble is binary, and 1010 represents the specific value of the preamble. In the embodiment, the preamble contains four bits in total. For any two adjacent bits in the four bits, such as “10”, “01”, the embodiment takes “01” as two adjacent bits for example.

First, obtain the initial sampling phase corresponding to the two adjacent bits, in the embodiment, sampling is performed at a frequency of 2 times which means each bit of the preamble is double oversampled. Therefore, each bit corresponds to two different initial sampling phase, FIG. 2 is a schematic diagram of the initial sampling phase corresponding to two adjacent bits in the embodiment of the invention, as shown in FIG. 2, D1 and D2 in the FIG. 2 represent two adjacent bits of the preamble. In the embodiment, D1 is “0” and D2 is “1” are taken as an example. The dotted lines S1 and S2 in the FIG. 2 are the two initial sampling phase of D1, which are called the first initial sampling phase and the second initial sampling phase respectively. The dotted lines S3 and S4 in the FIG. 2 are the two initial sampling phase of D2, which are called the third initial sampling phase and the fourth initial sampling phase respectively. S1, S2, S3 and S4 are the phase labels of the first initial sampling phase, the second initial sampling phase, the third initial sampling phase and the fourth initial sampling phase respectively. S1′ in the FIG. 2 is the initial sampling phase of bit behind D2.

S120, shifting each initial sampling phase to obtain each sampling phase after shift;

Then each initial sampling phase is shifted to obtain each sampling phase after shift, the specific shift direction and the specific shift size can be determined according to the actual situation, which are not specifically limited in the embodiment of the invention. Shifting each initial sampling phase means shifting each initial sampling phase to a fixed size in a certain direction at the same time. Each initial sampling phase after shifting is called the sampling phase after shift. Correspondingly, the sampling phase after shift includes the first sampling phase after shift, the second sampling phase after shift, the third sampling phase after shift and the fourth sampling phase after shift. The first sampling phase after shift is obtained by shifting the first initial sampling phase, the second sampling phase after shift is obtained by shifting the second initial sampling phase, the third sampling phase after shift is obtained by shifting the third initial sampling phase, and the fourth sampling phase after shift is obtained by shifting the fourth initial sampling phase.

It is easy to understand that for the initial sampling phase and the corresponding sampling phase after shift, the phase label of the sampling phase after shift does not change, which is the same as the initial sampling phase before the shift. The first sampling phase after shift, the second sampling phase after shift, the third sampling phase after shift, and the fourth sampling phase after shift are labeled S1, S2, S3, and S4, respectively.

In the embodiment, shifting each initial sampling phase means shifting each initial sampling phase forward by 0.25 bit. The first initial sampling phase, the second initial sampling phase, the third initial sampling phase and the fourth initial sampling phase are shifted forward by 0.25 bit respectively.

It should be noted that in the embodiment, forward refers to moving to the time ahead based on the time sequence, and backward refers to moving to the time behind based on the time sequence, referring to FIG. 2, forward means moving to the left and backward means moving to the right.

S130, based on whether the adjacent phase labels of the target jump edge before and after shifting are equal and whether the first reference sampling phase is located at the target jump edge, shifting each sampling phase after shift again, obtaining the optimal sampling phase corresponding to the two adjacent bits. The optimal sampling phase is closer to the middle phase of the corresponding preamble. The first reference sampling phase is the sampling phase after shift which is adjacent to the target jump edge and behind the target jump edge;

Then, according to whether the adjacent phase labels of the target jump edge before and after the shift are equal and whether the first reference sampling phase is located at the target jump edge, shifting each sampling phase after shift again. Specifically, the target jump edge refers to the jump edge between D1 bit and D2 bit. As can be seen from FIG. 2, the jump edge between the second initial sampling phase and the third initial sampling phase is the target jump edge.

After determining the target jump edge, it is also necessary to select the first reference sampling phase from the first sampling phase after shift, the second sampling phase after shift, the third sampling phase after shift, the fourth sampling phase after shift, according to the position relationship between the first sampling phase after shift, the second sampling phase after shift, the third sampling phase after shift and the fourth sampling phase after shift with the target jump edge. The specific selection method is to take the sampling phase after shift adjacent to the target jump edge and located behind the target jump edge as the first reference sampling phase.

If the first reference sampling phase is just located at the target jump edge, then all the sampling phase after shift are at a special position, each sampling phase after shift is shifted again according to the processing rules of the special position.

It should be noted that the first reference sampling phase is located at the target jump edge, which can be either the first reference sampling phase is located at the target jump edge, or the first reference sampling phase is located at a preset interval of the target jump edge, which can be determined according to the actual situation. The preset interval is obtained by taking the target jump edge as the reference point and extending forward and backward respectively. The specific length of the preset interval can be determined according to the actual situation. If the first reference sampling phase is located at the preset interval, it means that the first reference sampling phase is located at the target jump edge, on the contrary, the first reference sampling phase is not located at the target jump edge.

The two adjacent initial sampling phase along the target jump edge are the second initial sampling phase and the third initial sampling phase, therefore, the adjacent phase labels of the target jump edge before the shift are S2 and S3. The position of the target jump edge will not change after the shift, but the adjacent shift of the target jump edge may change according to the relative position of the third initial sampling phase in D2. The adjacent sampling phase of the target jump edge after the shift may be the second phase after shift and third sampling phase after shift, or the third phase after shift and fourth sampling phase after shift, that is, the adjacent phase labels of the target jump edge may be S2 and S3, or S3 and S4.

According to whether the adjacent phase labels of the target jump edge before and after the shift are equal, that is, whether the adjacent phase labels of the target jump edge after the shift are changed, to determine the direction of shifting each sampling phase after shift again. According to whether the adjacent phase labels of the target jump edge changes after the shift, the first sampling phase after shift, the second sampling phase after shift, the third sampling phase after shift and the fourth sampling phase after shift are shifted again, to obtain the final sampling phase which are the first final sampling phase, the second final sampling phase, the third final sampling phase and the fourth final sampling phase, respectively.

In the embodiment, the optimal sampling phase can be selected from several sampling phase, including the first final sampling phase, the second final sampling phase, the third final sampling phase, and the fourth final sampling phase. The optimal sampling phase is close to the middle phase of the corresponding preamble, and the specific selection method can be determined according to the actual situation, which is not specifically limited in this embodiment.

For example, after two more shifts, the final sampling phase of D1 preamble corresponds to the first final sampling phase and the second final sampling phase. Based on the middle phase of D1 preamble, if the first final sampling phase is closer to the middle phase than the second final sampling phase, then the first final sampling phase is taken as the optimum sampling phase of D1; if the second final sampling phase is closer to the middle phase than the first final sampling phase, then the second final sampling phase is taken as the optimum sampling phase of D1.

The final sampling phase of D2 preamble corresponds to the third final sampling phase and the fourth final sampling phase. Based on the middle phase of D2 preamble, if the third final sampling phase is closer to the middle phase than the fourth final sampling phase, then the third final sampling phase is taken as the optimum sampling phase of D2; if the fourth final sampling phase is closer to the middle phase than the third final sampling phase, then the fourth final sampling phase is taken as the optimum sampling phase of D2.

The optimal sampling phase in the embodiment includes the optimal sampling phase corresponding to each bit of the preamble. In the process of sampling the preamble, the more the sampling phase is shifted, the closer the sampling phase is to the middle phase of the preamble, so as to ensure sufficient window sampling margin and higher sampling accuracy. In the embodiment, due to the influence of the number of preamble, the sampling phase can only be shifted twice at most, so that the final optimal sampling phase is close to the middle phase of the corresponding preamble, which ensures sufficient window sampling margin. The closer the sampling phase is to the middle, the higher the sampling accuracy, so as to improve the sampling accuracy.

S140, sampling the valid data based on the optimal sampling phase corresponding to each bit of the preamble.

Finally, based on the optimal sampling phase corresponding to each bit of the preamble, the valid data of the GPON frame is sampled to complete the phase locking within the time specified in the GPON protocol.

In the specific implementation process, the hardware device executed in the embodiment is the same as the existing hardware device that sends data at the uplink rate of 1.24416 Gbps. When the uplink rate is upgraded to 2.48832 Gbps, the software code can be directly modified to achieve the uplink 2.48832 Gbps rate. Since there is no need to change the hardware equipment, thus saving the cost.

The invention provides a data double oversampling method, the initial sampling phase of the preamble bit is shifted twice, and finally the optimum sampling phase is extracted. The optimal sampling phase is close to the middle phase of the corresponding preamble, so as to ensure that there is sufficient window sampling margin, and improve sampling accuracy, and increase sampling accuracy. By sampling the valid data with the optimal sampling phase of the preamble, the phase locking of the recovered data can be stably completed within the time specified in the protocol; the method does not need to change the hardware equipment, thus saving the cost.

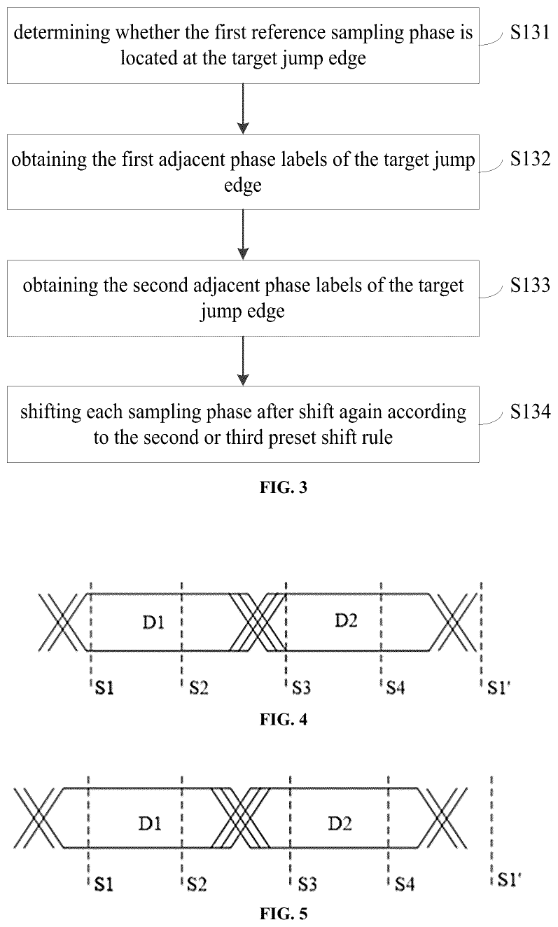

In the embodiment, FIG. 3 is a specific flow chart for determining a shift method according to adjacent phase labels in the embodiment of the invention, as shown in FIG. 3, in the step of S130, wherein that “based on whether the adjacent phase labels of the target jump edge before and after shifting are equal and whether the first reference sampling phase is located at the target jump edge, shifting each sampling phase after shift again” comprises:

S131, determining whether the first reference sampling phase is located at the target jump edge;

Firstly, it needs to determine whether the first reference sampling phase is located at the target jump edge, for specific determination methods, please refer to the above embodiments. In the case where the first reference sampling phase is located at the target jump edge, it indicates that the sampling phase is located at a special position. This situation should be handled separately. Specifically, shift each sampling phase after shift again according to the first preset shift rule, the first preset shift rule can be determined according to the actual situation, the embodiment does not provide specific limitations on this.

Optionally, the first preset shift rule comprises: shifting each sampling phase after shift backward by 0.25 bit. As an optional solution, in the embodiment, when the first reference sampling phase is located at the target jump edge, referring to FIG. 2, The third sampling phase after shift is taken as the first reference sampling phase, and the third sampling phase after shift is located at the target jump edge, which indicates that both the second initial sampling phase and the fourth initial sampling phase are located at the midpoint phase of the corresponding preamble. That is to say, the second initial sampling phase is located at the midpoint phase of D1, and the fourth initial sampling phase is located at the midpoint phase of D2. In the first shift, each initial sampling phase is shifted forward by 0.25 bit, therefore, in the second shift, only 0.25 bit need to be shifted backward to ensure that the optimal sampling phase is located in the middle phase of the corresponding preamble. Therefore, in the case where the first reference sampling phase is located at the target jump edge. During the second shift, each sampling phase after shift can be directly shifted backwards by 0.25 bit, without the need to judge the adjacent phase labels before and after the target jump edge shift.

S132, in the case where the first reference sampling phase is not located at the target jump edge, obtaining the first adjacent phase labels of the target jump edge according to the adjacent initial sampling phase of the target jump edge and the phase label of each initial sampling phase;

If the first reference sampling phase is not located at the target jump edge, the first adjacent phase labels is determined according to the adjacent initial phase and phase label of the target jump edge. Taking FIG. 2 as an example, it can be seen from the description of the above embodiment that the first adjacent phase labels in the embodiment are s2 and s3.

S133, obtaining the second adjacent phase labels of the target jump edge according to the adjacent sampling phase after shift of the target jump edge;

The second adjacent phase labels of the target jump edge is determined according to the sampling phase after shift of the target jump edge, due to the different positions of the third initial sampling phase in D2, the second adjacent phase labels of the target jump edge will be affected, the second adjacent phase labels will change depending on the position of the third initial sampling phase.

In the embodiment, according to the position relationship between the third initial sampling phase and D2, analysis was conducted separately. Finally the conclusion of shifting was drawn once again after summarizing. In the embodiment, the position relationship between the third initial sampling phase and D2 can be divided into the following four categories:

Due to the target jump edge being located between the second initial sampling phase and third initial sampling phase, the first initial sampling phase behind the target jump edge is the third initial sampling phase, therefore, the third initial sampling phase is taken as the reference sampling phase, and the shift is based on the reference sampling phase.

(1). The third initial sampling phase is in the first interval segment of D2, and the entire interval segment of D2 is 1 bit. The first interval segment ranges from 0 bit to ⅛ bit. FIG. 4 is a schematic diagram of the first interval segment of the third initial sampling phase in D2 in the embodiment of the invention, as shown in FIG. 4, in the case where the third initial sampling phase ranges from 0 bit to ⅛ bit, the adjacent sampling phase of the target jump edge are the second initial sampling phase and the third initial sampling phase, and the first adjacent phase labels of the target phase are s2 and s3. After shifting 0.25 bit left firstly, the third sampling phase after shift is located at the interval segment ranging from ¾ bit to ⅞ bit of D1. The adjacent sampling phase of the target jump edge is the third sampling phase after shift and the fourth sampling phase after shift. The second adjacent phase of the target phase is labeled as s3 and s4.

(2). The third initial sampling phase is in the second interval segment of D2, the first interval segment ranges from ⅛ bit to ¼ bit, FIG. 5 is a schematic diagram of the second interval segment of the third initial sampling phase in D2 in the embodiment of the invention, as shown in FIG. 5, in the case where the third initial sampling phase ranges from ⅛ bit to ¼ bit, the adjacent sampling phase of the target jump edge are the second initial sampling phase and the third initial sampling phase, and the first adjacent phase labels of the target phase are s2 and s3. After shifting 0.25 bit left firstly, the third sampling phase after shift is located at the interval segment ranging from ⅞ bit to 1 bit of D1. The adjacent sampling phase of the target jump edge is the third sampling phase after shift and the fourth sampling phase after shift. The second adjacent phase of the target phase is labeled as s3 and s4.

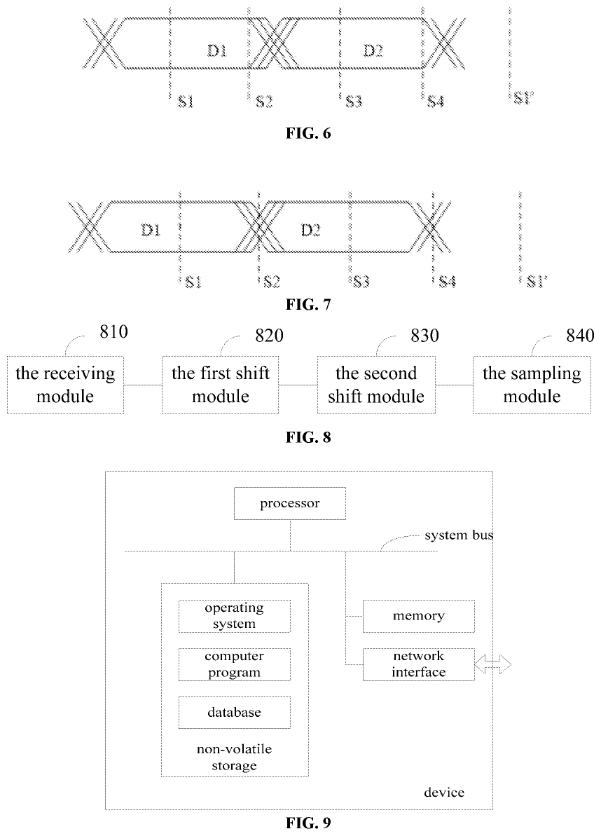

(3). The third initial sampling phase is in the third interval segment of D2, the third interval segment ranges from ¼ bit to ⅜ bit, FIG. 6 is a schematic diagram of the third interval segment of the third initial sampling phase in D2 in the embodiment of the invention, as shown in FIG. 6, in the case where the third initial sampling phase ranges from ¼ bit to ⅜ bit, the adjacent sampling phase of the target jump edge are the second initial sampling phase and the third initial sampling phase, and the first adjacent phase labels of the target phase are s2 and s3. After shifting 0.25 bit left firstly, the third sampling phase after shift is located at the interval segment ranging from 0 bit to ⅛ bit of D1. The adjacent sampling phase of the target jump edge is the second sampling phase after shift and the third sampling phase after shift. The second adjacent phase of the target phase is labeled as s2 and s3.

(4). The third initial sampling phase is in the fourth interval segment of D2, the third interval segment ranges from ⅜ bit to ½ bit, FIG. 7 is a schematic diagram of the fourth interval segment of the third initial sampling phase in D2 in the embodiment of the invention, as shown in FIG. 7, in the case where the third initial sampling phase ranges from ⅜ bit to ½ bit, the adjacent sampling phase of the target jump edge is the second initial sampling phase and the third initial sampling phase, and the first adjacent phase labels of the target phase are s2 and s3. After shifting 0.25 bit left firstly, the third sampling phase after shift is located at the interval segment ranging from ⅛ bit to ¼ bit of D1. The adjacent sampling phase of the target jump edge is the second sampling phase after shift and the third sampling phase after shift. The second adjacent phase of the target phase is labeled as s2 and s3.

S134, in the case where the first adjacent phase labels and the second adjacent phase labels are equal, shifting each sampling phase after shift again according to the second preset shift rule; in the case where the first adjacent phase labels and the second adjacent phase labels are not equal, shifting each sampling phase after shift again according to the third preset shift rule.

After the above analysis, it can be concluded that when the third initial sampling phase ranges from ¼ bit to ½ bit of D2, the second adjacent sampling phase is s2 and s3, and the first adjacent phase labels and the second adjacent phase labels are equal, on this occasion, each sampling phase after shift is shifted again according to the second preset shift rule. It can also be concluded that when the third initial sampling phase ranges from 0 bit to ¼ bit of D2, the second adjacent sampling phase is s3 and s4, and the first adjacent phase labels and the second adjacent phase labels are not equal, on this occasion, each sampling phase after shift is shifted again according to the third preset shift rule.

Optionally, the second preset shift rule comprises: shifting each sampling phase after shift forward by 0.125 bit. The third preset shift rule comprises: shifting each sampling phase after shift backward by 0.125 bit.

In the embodiment, when the third initial sampling phase ranges from 0 bit and ¼ bit of D2, the second adjacent sampling phase is s3 and s4, and the first adjacent phase labels and the second adjacent phase labels are not equal, on this occasion, each sampling phase after shift is shifted backward by 0.125 bit. When the third initial sampling phase ranges from ¼ bit and ½ bit of D2, the second adjacent sampling phase is s2 and s3, and the first adjacent phase labels and the second adjacent phase labels are equal, on this occasion, each sampling phase after shift is shifted forward by 0.125 bit.

In the specific implementation process, the initial sampling phase is shifted twice according to the above method, after simulation and actual testing, the experimental results show that phase locking can be completed within the time specified in the GPON protocol and the valid data is sampled with the optimum sampling phase.

In the embodiment, wherein before that “obtaining the first adjacent phase labels of the target jump edge according to the adjacent initial sampling phase of the target jump edge and the phase label of each initial sampling phase”, the method comprises:
obtaining initial sampling data by sampling the corresponding bit of each initial sampling phase;
performing an XOR on two adjacent initial sampling data;
in the case where the XOR value of the two adjacent initial sampling data is 1, the jump edge between the initial sampling phase corresponding to the two adjacent initial sampling data is taken as the target jump edge.

In the embodiment, a method for determining the target jump edge is also provided. Firstly, the bit corresponding to each initial sampling phase are sampled to obtain the initial sampling data, the initial sampling data includes the first initial sampling data, the second initial sampling data, the third initial sampling data, and the fourth initial sampling data, represented by d1, d2, d3, and d4, respectively. Specifically, D1 is sampled using the first initial sampling phase and second initial sampling phase to obtain the first initial sampling data and second initial sampling data. D2 is sampled using the third initial sampling phase and fourth initial sampling phase to obtain the third initial sampling data and fourth initial sampling data.

It needs to perform an XOR on any two adjacent initial sampling data from four initial sampling data, if d1 XOR d2 equals 1, it indicates that the target jump edge is between the second initial sampling phase and third initial sampling phase. Therefore, the jump edge between the second initial sampling phase and third initial sampling phase is taken as the target jump edge.

In the embodiment, wherein that “obtaining the optimal sampling phase corresponding to the two adjacent bits” comprises:
taking the initial sampling phase which is adjacent to the jump edge and located behind the target jump edge as the second reference sampling phase;
obtaining each final sampling phase after shifting each sampling phase after shift again;
taking the final sampling phase adjacent to the final reference phase as the optimal sampling phase, and the final reference phase is obtained by shifting the second reference sampling phase.

In the embodiment, each sampling phase after shift is shifted again to obtain the final sampling phase, which includes the first final sampling phase, the second final sampling phase, the third final sampling phase, and the fourth final sampling phase.

The third initial sampling data is the first bit data located behind the target jump edge. Therefore, the third initial sampling phase is taken as the second reference sampling phase, which corresponds to the third final sampling phase. The adjacent two final sampling phase of the third final sampling phase is taken as the optimal sampling phase, that is, the second final sampling phase and the fourth final sampling phase are taken as the optimal sampling phase.

In the embodiment, the first preset shift rule comprises: the steps S110 to S130 are executed concurrently at least once.

Specifically, the above steps S110 to S130 are executed concurrently at least once, and the data double oversampling method are executed concurrently multiple times. Performing the same step multiple times, even if there are occasional errors in one execution, it will not affect the results of other executions and nor will affect the final determination of the optimal sampling phase, so as to avoid the X-propagation.

FIG. 8 is the structural diagram of a data double oversampling system in the embodiment of the invention, as shown in FIG. 8, the system comprises:
the receiving module, for obtaining the initial sampling phase corresponding to the two adjacent bits and the phase label of each initial sampling phase, the GPON frame includes the preamble and valid data, for the two adjacent bits of the preamble in a GPON frame;
the first shift module, for shifting each initial sampling phase to obtain each sampling phase after shift;
the second shift module, for shifting each sampling phase after shift again, obtaining the optimal sampling phase corresponding to the two adjacent bits, based on whether the adjacent phase labels of the target jump edge before and after shifting are equal and whether the first reference sampling phase is located at the target jump edge. The optimal sampling phase is closer to the middle phase of the corresponding preamble. The first reference sampling phase is the sampling phase after shift which is adjacent to the target jump edge and behind the target jump edge;
the sampling module, for sampling the valid data based on the optimal sampling phase corresponding to each bit of the preamble.

Further, the second shift module includes the first judgment unit, the first shift unit, the first adjacent unit, the second judgment unit and the second judgment unit.
the first judgment unit, for determining whether the first reference sampling phase is located at the target jump edge;
the first shift unit, for shifting each sampling phase after shift again according to the first preset shift rule, in the case where the first reference sampling phase is located at the target jump edge;
the first adjacent unit, for in the case where the first reference sampling phase is not located at the target jump edge, obtaining the first adjacent phase labels of the target jump edge according to the adjacent initial sampling phase of the target jump edge and the phase label of each initial sampling phase;
the second adjacent unit, for obtaining the second adjacent phase labels of the target jump edge according to the adjacent sampling phase after shift of the target jump edge;
the second judgment unit, for in the case where the first adjacent phase labels and the second adjacent phase labels are equal, shifting each sampling phase after shift again according to the second preset shift rule; in the case where the first adjacent phase labels and the second adjacent phase labels are not equal, shifting each sampling phase after shift again according to the third preset shift rule.

Further, the first preset shift rule comprises: shifting each sampling phase after shift backward by 0.25 bit;
the second preset shift rule comprises: shifting each sampling phase after shift forward by 0.125 bit;
the third preset shift rule comprises: shifting each sampling phase after shift backward by 0.125 bit.

Further, the system also includes the initial module, the XOR module and the identify modules.
the initial module, for obtaining initial sampling data by sampling the corresponding bit of each initial sampling phase;
the XOR module, for performing an XOR on two adjacent initial sampling data;
the identify modules, for in the case where the XOR value of the two adjacent initial sampling data is 1, the jump edge between the initial sampling phase corresponding to the two adjacent initial sampling data is taken as the target jump edge.

Further, the second shift module includes the reference unit, the acquisition unit and the optimal unit.
the reference unit, for taking the initial sampling phase which is adjacent to the jump edge and located behind the target jump edge as the second reference sampling phase;
the acquisition unit, for obtaining each final sampling phase after shifting each sampling phase after shift again;
the optimal unit, for taking the final sampling phase adjacent to the final reference phase as the optimal sampling phase, and the final reference phase is obtained by shifting the second reference sampling phase.

Further, the first shift module includes the first shift submodule. the first shift submodule, for shifting each initial sampling phase forward by 0.25 bit to obtain each sampling phase after shift.

The various modules in the above data double oversampling system can be fully or partially implemented through software, hardware, and their combinations. The above modules can be embedded in hardware or independent of the processor in the computer device, or stored in software in the memory of the computer device for the processor to call and execute the corresponding operations of the above modules.

FIG. 9 is a schematic diagram of the structure of a computer device provided in an embodiment of the present invention. The computer device can be a server, and its internal structure diagram can be shown in FIG. 9. The computer device includes processor, memory, network interface, and database connected through a system bus. Among them, the processor of the computer device is used to provide computing and control capabilities. The memory of this computer device includes computer storage media and memory storage. The computer storage medium stores the operating system, computer program, and database. The memory provides an environment for the operation of the operating system and computer program in computer storage media. The database of the computer device is used to store data generated or obtained during the execution of the double oversampling method, such as preamble and valid data. The network interface of the computer device is used to communicate with external terminals through network connections. The computer program is executed by the processor to implement a data double oversampling method.

In an embodiment, a computer device is provided, comprising a memory, a processor, and a computer program stored in the memory and capable of running on the processor. When the processor executes the computer program, the steps of implementing the data double oversampling method in the above embodiment are described. Alternatively, the processor can implement the functions of each module/unit in the implementation example of a data double oversampling system when executing computer programs.

In an embodiment, a computer storage medium is provided, on which a computer program is stored. When the computer program is executed by the processor, the steps of the data double oversampling method in the above embodiment are implemented. Alternatively, when the computer program is executed by the processor, the functions of each module/unit in the implementation example of the double oversampling system for data mentioned above can be implemented.

Person skilled in the art in this field can understand that implementing all or part of the processes in the above embodiments can be accomplished by instructing the relevant hardware through computer program. The computer program can be stored in a non-volatile computer-readable storage medium, and when executed, the computer program may include processes in the embodiments of the above method. Among them, any reference to memory, storage, database, or other media used in the various embodiments provided in the invention may include non-volatile and/or volatile memory. Non volatile memory may include read-only memory (ROM), programmable ROM (PROM), electrically programmable ROM (EPROM), electrically erasable programmable ROM (EEPROM), or flash memory. Volatile memory may include random access memory (RAM) or external cache memory. As an explanation rather than limitation, RAM can be obtained in various forms, such as static RAM (SRAM), dynamic RAM (DRAM), synchronous DRAM (SDRAM), dual data rate SDRAM (DDRSDRAM), enhanced SDRAM (ESDRAM), synchronous link DRAM (SLDRAM), Rambus direct RAM (RDRAM), direct memory bus dynamic RAM (DRDRAM), and memory bus dynamic RAM (RDRAM).

Person skilled in the field can clearly understand that, for the convenience and conciseness of description, only the division of various functional units and modules mentioned above are given as an example. In practical applications, the above functions can be assigned to different functional units and modules according to needs, that is, the internal structure of the device can be divided into different functional units or modules to complete all or part of the functions described above.

The above is only the embodiment of the invention. It should be pointed out here that ordinary technicians in the art can make improvements without departing from the creative idea of the invention, but these belong to the protection scope of the invention.

1. A data double oversampling method, comprising:
obtaining the initial sampling phase corresponding to the two adjacent bits and the phase label of each initial sampling phase, the GPON frame includes the preamble and valid data for the two adjacent bits of the preamble in a GPON frame;
shifting each initial sampling phase to obtain each sampling phase after shift;
based on whether the adjacent phase labels of the target jump edge before and after shifting are equal and whether the first reference sampling phase is located at the target jump edge, shifting each sampling phase after shift again, obtaining the optimal sampling phase corresponding to the two adjacent bits, wherein the optimal sampling phase is closer to the middle phase of the corresponding preamble, and the first reference sampling phase is the sampling phase after shift which is adjacent to the target jump edge and behind the target jump edge; and
sampling the valid data based on the optimal sampling phase corresponding to each bit of the preamble.

2. The data double oversampling method of claim 1, wherein the step “based on whether the adjacent phase labels of the target jump edge before and after shifting are equal and whether the first reference sampling phase is located at the target jump edge, shifting each sampling phase after shift again” comprises:
determining whether the first reference sampling phase is located at the target jump edge;
in the case where the first reference sampling phase is located at the target jump edge, shifting each sampling phase after shift again according to the first preset shift rule;
in the case where the first reference sampling phase is not located at the target jump edge, obtaining the first adjacent phase labels of the target jump edge according to the adjacent initial sampling phase of the target jump edge and the phase label of each initial sampling phase;
obtaining the second adjacent phase labels of the target jump edge according to the adjacent sampling phase after shift of the target jump edge;
in the case where the first adjacent phase labels and the second adjacent phase labels are equal, shifting each sampling phase after shift again according to the second preset shift rule; and
in the case where the first adjacent phase labels and the second adjacent phase labels are not equal, shifting each sampling phase after shift again according to the third preset shift rule.

3. The data double oversampling method of claim 2, wherein the step “the first preset shift rule” comprises: shifting each sampling phase after shift backward by 0.25 bit;
wherein the second preset shift rule comprises: shifting each sampling phase after shift forward by 0.125 bit; and
wherein the third preset shift rule comprises: shifting each sampling phase after shift backward by 0.125 bit.

4. The data double oversampling method of claim 2, wherein before the step “obtaining the first adjacent phase labels of the target jump edge according to the adjacent initial sampling phase of the target jump edge and the phase label of each initial sampling phase”, the method comprises:
obtaining initial sampling data by sampling the corresponding bit of each initial sampling phase;
performing an XOR on two adjacent initial sampling data; and
in the case where the XOR value of the two adjacent initial sampling data is 1, the jump edge between the initial sampling phase corresponding to the two adjacent initial sampling data is taken as the target jump edge.

5. The data double oversampling method of claim 2, wherein the step “obtaining the optimal sampling phase corresponding to the two adjacent bits” comprises:
taking the initial sampling phase which is adjacent to the jump edge and located behind the target jump edge as the second reference sampling phase;
obtaining each final sampling phase after shifting each sampling phase after shift again; and
taking the final sampling phase adjacent to the final reference phase as the optimal sampling phase, and the final reference phase is obtained by shifting the second reference sampling phase.

6. The data double oversampling method of claim 1, wherein the steps of the method are executed concurrently at least once.

7. The data double oversampling method of claim 1, wherein the step “shifting each initial sampling phase to obtain each sampling phase after shift” comprises:
shifting each initial sampling phase forward by 0.25 bit to obtain each sampling phase after shift.

8. A data double oversampling system, comprising:
1 receiving module, for obtaining an initial sampling phase corresponding to the two adjacent bits and a phase label of each initial sampling phase, a GPON frame includes a preamble and valid data, for the two adjacent bits of the preamble in a GPON frame;
a first shift module, for shifting each initial sampling phase to obtain each sampling phase after shift;
a second shift module, for shifting each sampling phase after shift again, obtaining an optimal sampling phase corresponding to the two adjacent bits, based on whether adjacent phase labels of a target jump edge before and after shifting are equal and whether a first reference sampling phase is located at the target jump edge, wherein the optimal sampling phase is closer to a middle phase of a corresponding preamble, and the first reference sampling phase is the sampling phase after shift which is adjacent to the target jump edge and behind the target jump edge; and
a sampling module, for sampling the valid data based on the optimal sampling phase corresponding to each bit of the preamble.

9. A data double oversampling device, comprising a processor and a memory storing program instructions coupled to the processor; the processor being configured to execute the program instructions of memory storage in order to implement the method of claim 1.

10. A storage medium which stores program instructions, wherein when the program instructions is executed by a processor, the data double oversampling method of claim 1 is implemented.

11. The data double oversampling method of claim 2, wherein the steps of the method are executed concurrently at least once.

12. The data double oversampling method of claim 3, wherein the steps of the method are executed concurrently at least once.

13. The data double oversampling method of claim 2, wherein the step “shifting each initial sampling phase to obtain each sampling phase after shift” comprises:
shifting each initial sampling phase forward by 0.25 bit to obtain each sampling phase after shift.

14. The data double oversampling method of claim 3, wherein the step “shifting each initial sampling phase to obtain each sampling phase after shift” comprises:
shifting each initial sampling phase forward by 0.25 bit to obtain each sampling phase after shift.

15. A data double oversampling device, comprising a processor and a memory storing program instructions coupled to the processor; the processor being configured to execute the program instructions of memory storage in order to implement the method of claim 2.

16. A data double oversampling device, comprising a processor and a memory storing program instructions coupled to the processor; the processor being configured to execute the program instructions of memory storage in order to implement the method of claim 3.

17. A data double oversampling device, comprising a processor and a memory storing program instructions coupled to the processor; the processor being configured to execute the program instructions of memory storage in order to implement the method of claim 4.

18. A storage medium which stores program instructions, wherein when the program instructions is executed by a processor, the data double oversampling method of claim 2 is implemented.

19. A storage medium which stores program instructions, wherein when the program instructions is executed by a processor, the data double oversampling method of claim 3 is implemented.

20. A storage medium which stores program instructions, wherein when the program instructions is executed by a processor, the data double oversampling method of claim 4 is implemented.
